(19) United States
(12) Patent Application Publication
(10) Pub. No.: US 2024/0134607 A1
(43) Pub. Date: Apr. 25, 2024

(54) HARDWARE TO PERFORM SQUARING

(71) Applicant: Imagination Technologies Limited, Kings Langley (GB)

(72) Inventors: Max Freiburghaus, Hertfordshire (GB); William Wheeler, Hertfordshire (GB); Daniel Ley, Hertfordshire (GB)

(21) Appl. No.: 18/240,387

(22) Filed: Aug. 31, 2023

(30) Foreign Application Priority Data
Aug. 31, 2022 (GB) 2212603.1

(51) Int. Cl. G06F 7/552; G06F 7/40

(52) U.S. Cl. CPC G06F 7/5525; G06F 7/405

(57) ABSTRACT

Methods of calculating a square of an input number in hardware logic are described. An m-bit number is received and Booth encoding is performed on different groups of three consecutive bits selected from the input to generate an encoded value for each of the groups. For each group, the method comprises forming a truncated string from the input number, generating an updated version of the truncated number and selecting a bit string based on the encoded value, the selected bit string comprising zeros or a left-shifted version of the updated version of the truncated number sign extended to a bit-width of 2m bits. The method further comprises combining the selected bit strings and square and sign bits for each group into an addition array; and summing the bits in the addition array.

### CROSS-REFERENCE TO RELATED APPLICATION

This application claims foreign priority under 35 U.S.C. 119 from United Kingdom patent application number 2212603.1 filed on 31 Aug. 2022, which is herein incorporated by reference in its entirety.

### BACKGROUND

Squaring of an input number is a fundamental operation that has many applications (e.g. when determining the length of a vector, which is given by a sum of squares). As a result, processors (e.g. CPUs or GPUs) may contain dedicated squarer hardware and the size of this hardware affects the overall size of the processor.

The embodiments described below are provided by way of example only and are not limiting of implementations which solve any or all of the disadvantages of known method of implementing squaring in hardware logic.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods of calculating a square of an input number in hardware logic are described. An m-bit number is received and Booth encoding is performed on different groups of three consecutive bits selected from the input to generate an encoded value for each of the groups. For each group, the method comprises forming a truncated string from the input number, generating an updated version of the truncated number and selecting a bit string based on the encoded value, the selected bit string comprising zeros or a left-shifted version of the updated version of the truncated number sign extended to a bit-width of 2m bits. The method further comprises combining the selected bit strings and square and sign bits for each group into an addition array; and summing the bits in the addition array.

A first aspect provides a method of calculating a square of an input number in hardware logic, the method comprising: receiving an m-bit number, where m is an even integer; performing Booth encoding on a plurality of different groups of three consecutive bits selected from the m-bit number to generate an encoded value for each of the groups of bits; for each group of three consecutive bits: forming a truncated string from the input number; generating an updated version of the truncated number using the most significant bit of the group of three consecutive bits; and selecting a bit string based on the encoded value, the selected bit string comprising zeros or a left-shifted version of the updated version of the truncated number sign extended to a bit-width of 2m bits; combining the selected bit strings for each of the groups and square and sign bits for each group into an addition array, the square bits for a group comprise two bits set based on the encoded value for the group and the sign bit for a group comprises a bit set based on the three consecutive bits in the group; and summing the bits in the addition array.

A second aspect provides a method of calculating a sum of squares in hardware logic, the method comprising: receiving two or more input floating point numbers, each number comprising an exponent and a mantissa; for each input floating point number, calculating a square of the mantissa of each input number according to the method of the first aspect or any other method described herein; and summing the calculated squares.

A third aspect provides hardware logic configured to perform the method of the first or second aspect or any other method described herein.

The processor, squarer or other hardware logic configured to perform a method as described herein may be embodied in hardware on an integrated circuit. There may be provided a method of manufacturing, at an integrated circuit manufacturing system, a processor, squarer or other hardware logic configured to perform a method as described herein. There may be provided an integrated circuit definition dataset that, when processed in an integrated circuit manufacturing system, configures the system to manufacture a processor, squarer or other hardware logic configured to perform a method as described herein. There may be provided a non-transitory computer readable storage medium having stored thereon a computer readable description of an integrated circuit that, when processed, causes a layout processing system to generate a circuit layout description used in an integrated circuit manufacturing system to manufacture a processor, squarer or other hardware logic configured to perform a method as described herein.

There may be provided an integrated circuit manufacturing system comprising: a non-transitory computer readable storage medium having stored thereon a computer readable integrated circuit description that describes a processor, squarer or other hardware logic configured to perform a method as described herein; a layout processing system configured to process the integrated circuit description so as to generate a circuit layout description of an integrated circuit embodying a processor, squarer or other hardware logic configured to perform a method as described herein; and an integrated circuit generation system configured to manufacture a processor, squarer or other hardware logic configured to perform a method as described herein according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Examples will now be described in detail with reference to the accompanying drawings in which:

FIG. 1 is a flow diagram of a first example method of performing squaring of an input binary number;

FIG. 2 is a schematic diagram showing an example arrangement of hardware logic that may be used to perform the Booth encoding and generate the sign and square bits;

FIG. 3 shows a graphical representation of a bit string that is formed by the interleaving of the square and sign bits;

FIG. 4 is a flow diagram of a second example method of performing squaring of an input number;

FIG. 5 is a flow diagram of a third example method of performing squaring of an input number which is a variation on that shown in FIG. 1;

FIG. 6A shows an addition array for m=24 generated using the method of FIG. 5;

FIG. 6B shows an addition array for p=9 generated using the method of FIG. 4;

FIG. 7A shows the truncated array for the example of FIG. 6A;

FIG. 7B shows an addition array for m=16;

FIG. 8 is a flow diagram of an example method of calculating a sum of squares;

FIGS. 9A, 9B. 10A and 10B show various graphical representations of example sums of squares; and

FIG. 11 shows an integrated circuit manufacturing system for generating an integrated circuit embodying a processor, squarer or other hardware logic configured to perform a method as described herein.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

Described herein are improved methods for performing squaring of an input number (e.g. an m-bit input binary number) in hardware logic. The input number may be a signed input number or an unsigned input number. In various examples, the input number may comprise an even number of bits (i.e. m is an even number) and in other examples the input number may comprise an even or an odd number of bits. An optional right-truncation step is also described (which truncates two or more of the least significant columns, LSCs) which may be implemented before the summation of the array, for example, when squaring floating point numbers (e.g. where the input number is the mantissa of a floating point number) or when squaring other types of numbers (e.g. integers). Where the right-truncation is not used, the methods described here return the exact result or the result can be truncated or rounded (using known techniques) to a desired precision (e.g. a desired number of most significant bits, MSBs) of the result from the array summation. Where right-truncation is used, the methods described here provide a faithfully rounded result by adding a constant correction term into the array that compensates for the worst-case error from the truncation of the LSCs, before adding the rows up and performing a further truncation of the result at the required precision. Also described herein are methods for performing faithfully rounded sums of two or three squares. The term ‘faithfully rounded’ is used herein to refer to the fact that the error (as a consequence of the truncation and rounding) is strictly less than one unit of least precision (ULP) in the result. This means that the method returns the exact answer if it is representable and otherwise rounds either up or down.

The methods described herein can be implemented efficiently in hardware. There is a trade-off between area of hardware and delay (with smaller hardware resulting in larger delays); however using the methods described herein, the size of the hardware is reduced compared to known hardware implementations with comparable delays. There is also a trade off between area of hardware and accuracy—if for a particular application, a larger inaccuracy can be accommodated, then more LSCs can be truncated in the right-truncation operation before row addition and this results in further hardware area savings.

Where the optional right-truncation is performed (before the summation of the array), the addition of the constant correction term adds very little in terms of hardware (e.g. as it may be merged into buffer/inverter trees in synthesis) but enables (i) removal of encodings for fully truncated rows (see later discussion of iₘᵢₙ), (ii) removal of multiplexers for fully and partly truncated rows, (iii) removal of carry-save-adder (CSA) hardware for summation, and (iv) removal of some carry-propagation in summation (in the critical path).

The methods described herein use Booth encoding. Booth encoding is known to result in a general multiplier array of half the height of an AND-array for the same calculation, thereby reducing the number of variable bits by half, compared to the AND-array. Known AND-array squarers exploit the symmetry of a general multiplier AND-array when used for squaring, thereby almost halving the number of variable bits. These two known techniques cannot be easily combined. The methods described herein use Booth encoding and multiplexing in a different way to known techniques to combine the advantages of both of the known optimisations above, thereby reducing the number of variable bits in the resulting squarer array by almost three quarters compared to a general, unoptimised AND-array for the same calculation. In particular, the use of Booth encoded multiplexers halves the array height compared to an AND array as in a general Booth multiplier. Using the unencoded left-truncated input as the rows into Booth-multiplexers provides a further reduction by half the multiplexing area.

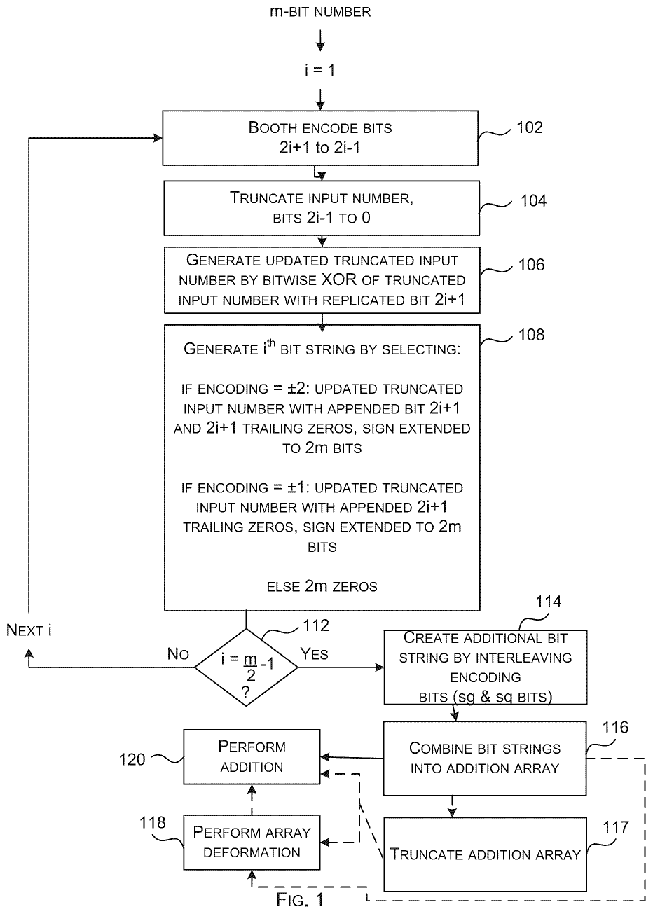

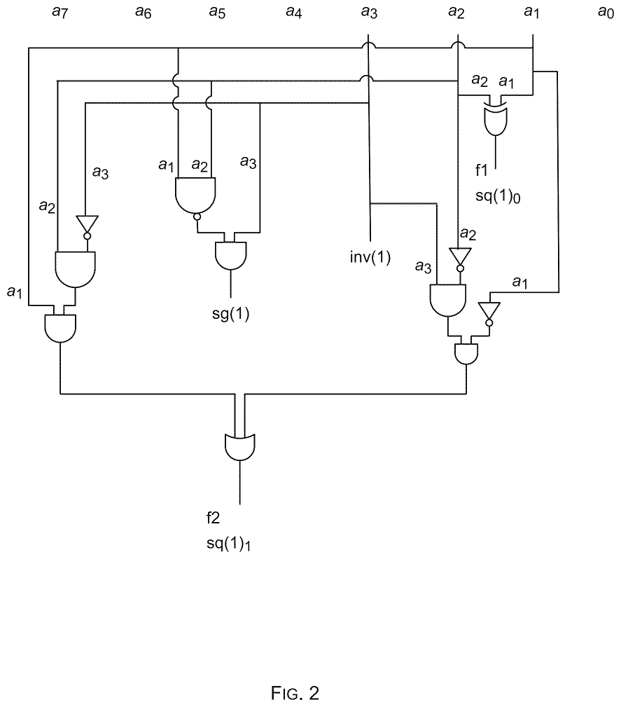

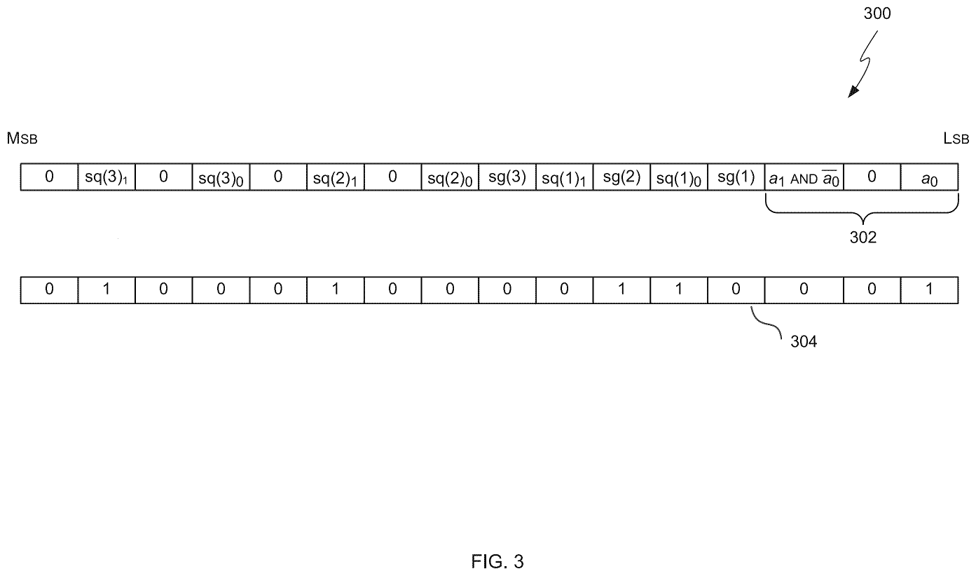

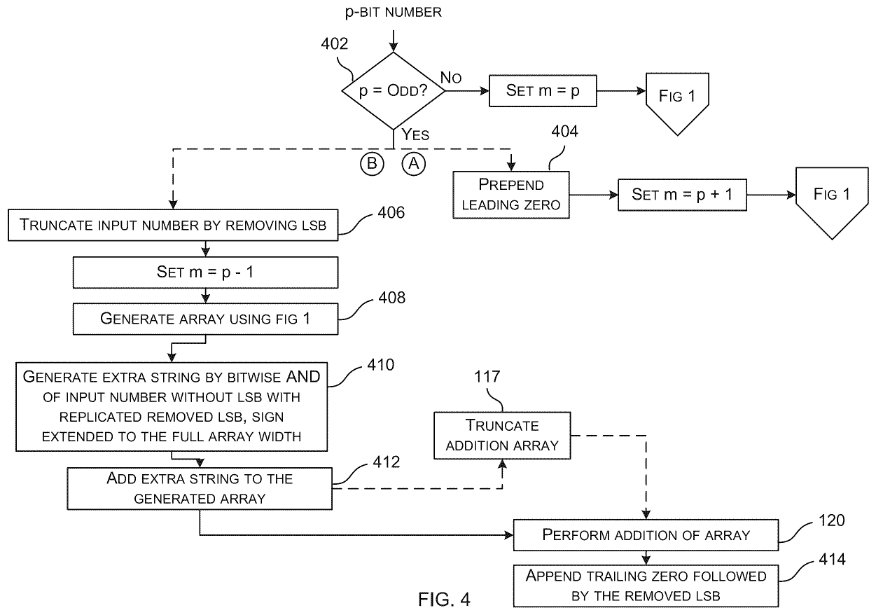

FIG. 1 is a flow diagram of a first example method of performing squaring of an input binary number which may be implemented efficiently in hardware logic (e.g. in smaller hardware logic compared to known techniques with a comparable delay performance). As shown in FIG. 1, the input number is an m-bit input number and in this method m is an even integer and the input number is a signed number (e.g. using two's complement notation). The method comprises performing Booth encoding on a plurality of different groups of three consecutive bits selected from the input number (block 102), one group for each iteration of the loop where the loop is repeated for each value of i from i=1 to i=(m/2)−1 (blocks 102-112). Each iteration of the loop generates a bit string, referred to as the i^{th} bit string, that is subsequently combined into an addition array (block 116) with an additional bit string that is also created (in block 114).

As shown in FIG. 1, a group of three consecutive bits is selected from the input number based on the value of i (block 102). These three bits may be denoted a₂ᵢ₊₁, a₂ᵢ, a₂ᵢ₋₁. The variable, i, is an integer that in the implementation shown is initially is set with i=1 and increments by one for each loop; however it will be appreciated that the iterations may be performed in a different order (e.g. starting at i=(m/2)−1 and decrementing by one for each successive iteration until i=1 in the final iteration) or substantially in parallel. A truncated string is formed from the input number (block 104). This truncation (in block 104) results in a bit string comprising bits 2i−1 to 0 (where bit 0 is the LSB) and so this truncation may be referred to as left-truncation (as opposed to the right-truncation which may be applied to the addition array once formed). Left-truncation involves removing zero, one or more MSBs, whereas right-truncation involves removing zero, one or more LSBs or LSCs dependent upon whether the truncation is applied to a bit string (selective removal of bits) or array of bit strings (selective removal of one or more columns).

The left-truncated string (i.e. the truncated version of the input number) is then manipulated based on the corresponding encoding (blocks 106 and 108). This manipulation comprises an optional inversion of the truncated input number dependent upon the value of bit 2i+1 (a₂ᵢ₊₁), i.e. such that the truncated input number is inverted if the value of bit 2i+1 is a one but is not inverted if the value of bit 2i+1 is zero. As shown in FIG. 1, this may be implemented by performing a bitwise XOR of the truncated input number with a replicated bit 2i+1 (in block 106), i.e. such that each bit of the truncated input number is XORed with the same value of bit 2i+1. As bit 2i+1 controls whether inversion happens (in block 106), it may be referred to as the inversion bit, inv(i).

An i^{th} bit string is then generated based on the Booth encoding (from block 102) and the updated truncated input number (from block 106) as shown in the table below:

| Booth | |
|---|---|
| Encoding | i^{th} bit string |
| ±2 | Updated truncated input number with appended bit 2i + 1 |
| | and 2i + 1 trailing zeros, sign extended to 2m bits |
| ±1 | Updated truncated input number with appended 2i + 1 |
| | trailing zeros, sign extended to 2m bits |
| 0 | 2m zeros |

This generation of the i^{th} bit string may be implemented by generating each of the options and then selecting between them using a multiplexer, where the multiplexer makes the selection based on the value of the Booth encoding. Whilst the selection of 2m zeros is shown as being when the Booth encoding is zero, it will be appreciated that it may be implemented as the default position in the event that the Booth encoding is not ±1 or ±2.

The encodings that are performed (in block 102) each generate an encoded value and the encoded values are in the range of −2 to +2 (i.e. they are 0, ±1 or ±2). Each encoding may therefore define two bits, referred to as the square bits, sq(i)₁sq(i)₀, corresponding to the magnitude of the encoded value in binary (i.e. sq(i)₁sq(i)₀=01 for ±1, sq(i)₁sq(i)₀=10 for ±2 and sq(i)₁sq(i)₀=00 for 0). A further bit string is generated by interleaving these square bits with a series of sign bits (block 114). The sign bits, sg(i), may be generated from the three bits in the group (as selected in block 102), a₂ᵢ₊₁, a₂ᵢ, a₂ᵢ₋₁. In an example, sg(i)=a₂ᵢ₊₁ AND (a₂ᵢ NAND a₂ᵢ₋₁). The generation of this additional string is described in more detail below with reference to FIG. 3. This additional bit string is included in the addition array (in block 116) and addition may then be performed on the array (block 120).

It will be appreciated that the sign bit, sg(i), could alternatively be used to control the optional inversion (in block 106) instead of inv(i) since they only differ where the encoded value is zero (in which case the i^{th} bit string always comprises 2m zeros and is independent of the truncation); however, since inv(i) is equal to the value of bit 2i+1 (a₂ᵢ₊₁), it is available immediately and there is no delay involved whilst it is generated.

As shown in FIG. 1, (m/2)−1 encodings are generated (in block 102, for i=1 to i=(m/2)−1) and so m/2 bit strings are generated and included in the addition array (in block 116), although some of these bit strings may be all zeros (i.e. where the encoding is zero). This results in a very compact addition array (e.g. in terms of the number of rows) and hence the addition (in block 120) can be efficiently implemented (e.g. with an arrangement of adders, such as an arrangement of carry-save adders, CSA, followed by a carry-propagate adder, CPA) in hardware. The stages of the method of FIG. 1 are described in more detail below.

For a particular value of i in the range from 1 to (m/2)−1, the three consecutive bits of the m-bit input number that are encoded using Booth encoding (in block 102) are those bits with a bit index in the range 2i+1 to 2i−1, i.e. bits 2i+1, 2i and 2i−1 (where the LSB is bit 0 and the MSB is bit m−1). So for an 8-bit signed input number (m=8) a₇a₆a₅a₄a₃a₂a₁a₀, three Booth encodings are performed (one in each loop of the method of FIG. 1), the first, for i=1, using bits a₃, a₂, a₁, the second, for i=2, using bits a₅, a₄, a₃, and the third, for i=3, using bits a₇, a₆, a₅. The Booth encoded values along with the resulting square and negation bits are given in the table below.

| | | | Encoded | | | | |
|---|---|---|---|---|---|---|---|
| a₂ᵢ₊₁ | a₂ᵢ | a₂ᵢ₋₁ | value | inv(i) | sg(i) | sq(i)₁ | sq(i)₀ |
| 0 | 0 | 0 | 0 | 0 | 0 | 0 | 0 |
| 0 | 0 | 1 | +1 | 0 | 0 | 0 | 1 |
| 0 | 1 | 0 | +1 | 0 | 0 | 0 | 1 |
| 0 | 1 | 1 | +2 | 0 | 0 | 1 | 0 |
| 1 | 0 | 0 | −2 | 1 | 1 | 1 | 0 |
| 1 | 0 | 1 | −1 | 1 | 1 | 0 | 1 |
| 1 | 1 | 0 | −1 | 1 | 1 | 0 | 1 |
| 1 | 1 | 1 | 0 | 1 | 0 | 0 | 0 |

FIG. 2 is a schematic diagram showing an example arrangement of hardware logic that may be used to perform the Booth encoding and generate the sign and square bits. Whilst this is shown for i=1, a copy of the hardware, may be used for each value of i. In various examples the squarer hardware may comprise (m/2)−1 instances of this Booth encoding hardware.

FIG. 3 shows a graphical representation of the additional bit string 300 that is formed by the interleaving of the square and sign bits (in block 114) for m=8, although the same pattern may be used for other values of m, resulting in a shorter or longer version of the string 300 shown in FIG. 3 if m<8 or m>8 respectively. As shown in FIG. 3, the three LSBs 302 of this additional bit string 300 are not formed from the square or sign bits. The LSB (bit 0) is set equal to the LSB of the input in-bit number, a₀. Bit 1 is set to zero (in all cases) and bit 2 is set based on the values of the two LSBs of the input number and is determined to be a₁ AND NOT a₀. Subsequent to that the bits in the bit string comprise sign bits (with increasing values of i) interleaved with square bits (sq(i)₀, sq(i)₁ with increasing values of i) and for i>(m/2)−1, where there are no sign or square bits which have been set, the additional bit string comprises zeros. It will be appreciated that there is no hardware cost associated with a bit that is always zero (i.e. has a fixed value of zero).

In an example, if the input number is 99 in binary, 01100011 (m=8), then the encoded value and the values of the negation and square bits are given below:

| | | | | Encoded | | | |
|---|---|---|---|---|---|---|---|
| i | a₂ᵢ₊₁ | a₂ᵢ | a₂ᵢ₋₁ | value | sg(i) | sq(i)₁ | sq(i)₀ |
| 1 | 0 | 0 | 1 | +1 | 0 | 0 | 1 |
| 2 | 1 | 0 | 0 | −2 | 1 | 1 | 0 |
| 3 | 0 | 1 | 1 | +2 | 0 | 1 | 0 |

The bit string 304 that is formed using these bits by performing the interleaving described above is shown in FIG. 3.

By handling the sign and square bits as described above (and shown in FIG. 3) and including them in a single bit string which is added to the addition array (in block 116), the hardware required to generate the remaining bit strings for the addition array (e.g. for the various values of i) is simplified. As described above, the remaining bit strings are either all zeros or sign extended left-truncations of the optionally inverted input number, dependent on the encoded value. No addition operations are required when forming the bit strings.

As described above, as well as using the Booth encodings to generate the additional bit string (in block 114), a bit string is generated (in blocks 102-112), for each value of i from i=1 to i=(m/2)−1. The generation of the i^{th} bit string comprise left-truncation of the input number to generate a truncated bit string that comprises bits 2i−1 to 0 from the m-bit input number (in block 104). Referring back to the earlier example for an 8-bit input number (m=8) a₇a₆a₅a₄a₃a₂a₁a₀, three truncated strings are formed as shown below:

| i | Truncated string |
|---|---|
| 1 | a₁a₀ |
| 2 | a₃a₂a₁a₀ |
| 3 | a₅a₄a₃a₂a₁a₀ |

Referring back to the example where the input number is 99 in binary, 01100011 (m=8), the truncated strings and the corresponding manipulation (in blocks 106 and 108) is shown below. In the bottom row of the table, the bits from the string prior to block 108 (and hence after block 106) are shown underlined and the appended bit 2i+1, in the case that the encoding is ±2, is shown in bold so that the trailing zeros and sign extended bits can be more clearly seen.

| | i = 1 | i = 2 | i = 3 |
|---|---|---|---|
| | (encoded value +1) | (encoded value −2) | (encoded value +2) |
| Truncated string | 11 | 0011 | 100011 |
| (after block 104) | | | |
| Optionally inverted | 11 | 1100 | 100011 |
| truncated string | | | |
| (after block 106) | | | |
| i^{th} bit string | 1111111111111000 | 1111111100100000 | 1110001100000000 |
| (after block 108) | | | |

Having generated the bit strings, as described above, they are combined to form an addition array (block 116) and the addition may be performed (block 120) and the result (a 2m-bit number) output. Referring back to the example where the input number is 99 in binary, 01100011 (m=8), the addition array is shown below with the top three rows corresponding to i=1, 2, 3 and the bottom row being the additional bit string formed by interleaving the negation and square bits:

| | | | | | | | | | | | | | | | |
|---|---|---|---|---|---|---|---|---|---|---|---|---|---|---|---|
| 1 | 1 | 1 | 1 | 1 | 1 | 1 | 1 | 1 | 1 | 1 | 1 | 1 | 0 | 0 | 0 |
| 1 | 1 | 1 | 1 | 1 | 1 | 1 | 1 | 0 | 0 | 1 | 0 | 0 | 0 | 0 | 0 |
| 1 | 1 | 1 | 0 | 0 | 0 | 1 | 1 | 0 | 0 | 0 | 0 | 0 | 0 | 0 | 0 |
| 0 | 1 | 0 | 0 | 0 | 1 | 0 | 0 | 0 | 0 | 1 | 1 | 0 | 0 | 0 | 1 |

In various examples, the addition array (as formed in block 116) may be deformed (block 118) prior to performing the addition (in block 120) and this further increases the efficiency of the hardware (as described below, where the optional array truncation is performed, in block 117, this is performed before array deformation). As described below, array deformation eliminates all sign extensions using only (m/2)−1 inverter cells and some added constant bits and hence reduces the number of variable bits in the array significantly. As described above, there is no hardware cost of handling a bit with a fixed value of zero and the hardware cost of handling a bit with a fixed value of one is significantly lower than a variable bit (even if that variable bit has a value of zero).

Array deformation (in block 118) may be performed by inverting the sign bit, i.e. bit 4i+1, in each of the i bit strings formed by manipulation of truncations of the original input string (in blocks 106 and 108), setting the next three most significant bits (i.e. bits 4i+4, 4i+3 and 4i+2) equal to one and setting any more significant bits (i.e. bits 2m−1 to 4i+5) to zero. For some larger values of i, there may not be sufficient bits in the string to perform all these operations (i.e. where (2m−1)<(4i+4)) and so the operation is performed until there are no more significant bits to consider. In addition, a further bit string is included which comprises a single 1 in bit position 4iₘᵢₙ+1 where, for fully accurate or RTZ (round towards zero) arrays, iₘᵢₙ=1, whereas if right-truncation is used, iₘᵢₙ is equal to the value of i for the first row in the array that is not fully truncated (as described below, any row only comprising sign extension bits after the right-truncation is fully truncated). Given a truncation parameter, t, that defines the number of LSCs that are truncated in the right-truncation operation, iₘᵢₙ=└((t+2)/4)┘. The value of t is defined at design time (as described in more detail below).

Referring back to the example where the input number is 99 in binary, 01100011 (m=8), where the optional array deformation (in block 118) is performed, the addition array is shown below with new bit string shown at the top (with the with one in position 4iₘᵢₙ+1 for i=1, shown in bold) and the inverted bit (in position 4i+1) in each of the i bit strings formed by manipulation of truncations of the original input (i.e. in all the other bit strings except the additional bit string generated in block 114) shown underlined:

| | | | | | | | | | | | | | | | |
|---|---|---|---|---|---|---|---|---|---|---|---|---|---|---|---|
| 0 | 0 | 0 | 0 | 0 | 0 | 0 | 0 | 0 | 0 | 1 | 0 | 0 | 0 | 0 | 0 |
| 0 | 0 | 0 | 0 | 0 | 0 | 0 | 1 | 1 | 1 | 0 | 1 | 1 | 0 | 0 | 0 |
| 0 | 0 | 0 | 1 | 1 | 1 | 0 | 1 | 0 | 0 | 1 | 0 | 0 | 0 | 0 | 0 |
| 1 | 1 | 0 | 0 | 0 | 0 | 1 | 1 | 0 | 0 | 0 | 0 | 0 | 0 | 0 | 0 |
| 0 | 1 | 0 | 0 | 0 | 1 | 0 | 0 | 0 | 0 | 1 | 1 | 0 | 0 | 0 | 1 |

As can be seen from this example, the array deformation (in block 118) does not reduce the number of rows in the addition array, and in fact increases the number of rows by one, but does significantly reduce the number of ones (i.e. sign extension ones) that are in the addition array and this results in a more efficient hardware implementation because, as described above, all constant zeros (i.e. zeros which are known at design time) do not incur any hardware cost and constant ones are less costly in terms of hardware area than variable bits (i.e. bits where the value of the bit is only known at input time).

It will be appreciated that whilst the particular stages of the method of FIG. 1 are shown in a particular order, some of them may be performed in a different order without changing the overall method. For example, the method may be repeated for decreasing values of i (e.g. starting at i=(m/2)−1) or all the encoding and string manipulation operation for different values of i may be performed substantially in parallel.

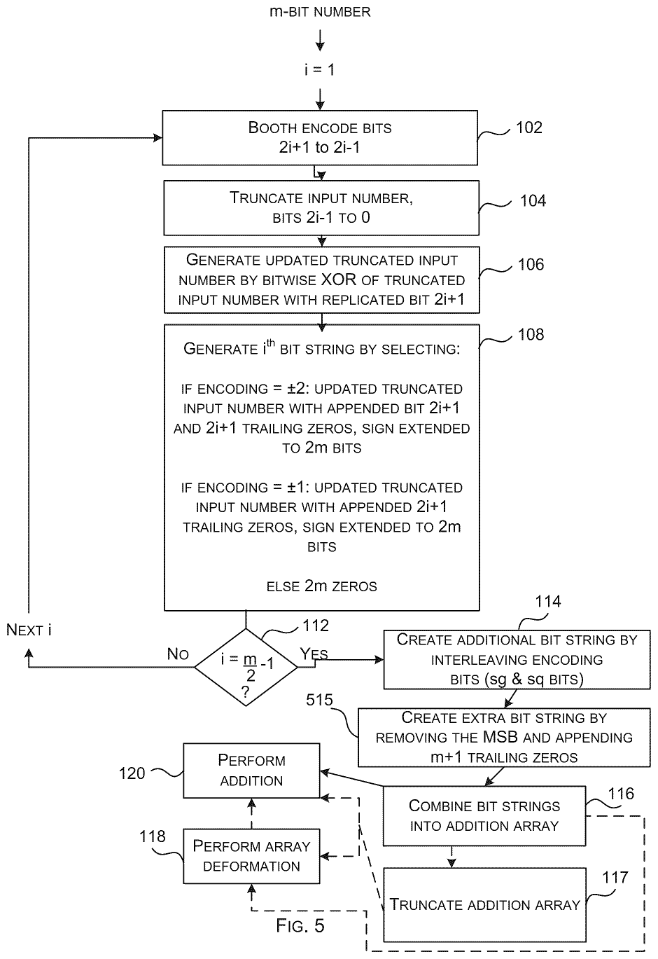

As described above, the method of FIG. 1 may be used where there are an even number of bits in the input number, i.e. m is even, and the input number is a signed number (e.g. in two's complement notation). FIG. 4 is a flow diagram of a second example method of performing squaring of an input number which may be implemented efficiently in hardware logic (e.g. in smaller hardware logic compared to known techniques with a comparable delay performance). As shown in FIG. 4, the input number is a p-bit input number, where p may be an even or an odd integer and the method is a variation on that shown in FIG. 1 and described above.

In the event that p is an even integer (‘No’ in block 402), the method proceeds as shown in FIG. 1, with m=p. In the event that p is an odd integer (‘Yes’ in block 402), then two different methods are shown. The first method (method A), may be used when p is odd and the input number is unsigned. In this method, a leading zero is prepended to the input number (block 404) so that it now comprises a signed number comprising an even number of bits and the method proceeds as shown in FIG. 1, with m=p+1; however with the simplification that the two most significant columns (MSCs) can be removed from all steps of the method of FIG. 1 as they exceed the width, 2p, that is required to fully encode the final result. The second method (method B), may be used when p is odd and the input number is signed. Instead of prepending a bit to the input number (as in method A), the p-bit input number is truncated by removing the LSB (block 406) so that again, there are an even number of bits in the resulting string. The method then proceeds to generate an addition array using the truncated string and the method of FIG. 1 with m=p−1 (block 408) but stopping the method of FIG. 1 prior to the performing the addition (in block 120), i.e. the method of FIG. 1 stops after block 116 (creation of the addition array). Having generated the array (in block 408, using the method of FIG. 1 up to and including block 116), an extra string is generated by performing a bitwise AND of the truncated input number (i.e. the p-bit input number without the LSB, as generated in block 406) and the replicated LSB (block 410) and then sign extending the result to the width of the addition array (as generated in block 408). This means that if the LSB of the original p-bit number that was removed is one, then the extra string corresponds to the truncated input number (from block 406) sign extended to the full array width and if the LSB of the p-bit input number is zero, the extra string comprises all zeros. This extra string is then added to the previously generated addition array (block 412). Having included the extra row in the addition array (in block 412), the addition is performed (in block 120) and then a trailing zero followed by the previously removed LSB is appended to the result of the addition (block 414).

As described above, the method of FIG. 1 may be used where the input number is signed and comprises an even number of bits and the method of FIG. 4 may be used where the input number comprises an odd number of bits, with method A being used if the input number is unsigned and method B being used if the input number is signed. If instead, the input number comprises an even number of bits and is unsigned, the method of FIG. 1 may be modified as shown in FIG. 5. As shown in FIG. 5, the method of FIG. 1 is modified by generating an extra bit string by removing the MSB and appending m+1 trailing zeros (block 515) and this is included in the addition array (in block 116). An alternative approach to that shown in FIG. 5 would be to pad the original input number with two zeros and then using the method of FIG. 1 with m set to the number of bits in the padded input number (i.e. with m set to m+2), but this increases the width of the addition array (as formed in block 116) by 4 bits.

In the methods described above, the output comprises the full result of the addition of the bits in the addition array (i.e. a 2m-bit number) and hence the result provided is the exact (or fully accurate) result. In various, examples, however, only a reduced precision output may be required. In such examples, only a subset of the bits are required to be output and either the result of the addition (in block 120) may be truncated or the addition array may be right-truncated prior to performing the addition (block 117), i.e. such that the output comprises fewer than 2m bits. Performing right-truncation (in block 117) before performing addition results in a reduction in the hardware requirements (and hence hardware area) but introduces a variable error that may be controlled by the addition of a constant correction term (CCT). The CCT is added to approximately compensate for the value of the bits removed by the truncation. By ensuring that the worst-case truncation (i.e. the maximum possible value of the truncated bits) is less than the CCT, the error after right-truncation and correction is always positive, and the maximum error resulting from the truncation followed by the addition of the CCT is equal to the CCT. In various examples, the CCT may be set to be less than a unit of least precision (ULP) in the output result. Returning the MSBs to the required output precision after performing the addition (in block 120) on an array that was truncated and corrected by this method ensures that the output is faithfully rounded to this precision: in particular, the result is not smaller than the RTN (round to negative) result from an untruncated, uncorrected array would have been, because the CCT ensures that any negative truncation error is fully compensated. Furthermore, the result is not greater than the RTP (round to positive) result from an untruncated, uncorrected array would have been because the maximum error is equal to the CCT, which was chosen to be less than a ULP with respect to the output precision. As shown in FIGS. 1 and 5, where right-truncation is performed, it is performed before any array deformation (in block 118) which, like the right-truncation (in block 117), is also optional.

When performing right-truncation (in block 117) the amount of truncation is defined by a truncation parameter, t, that defines the number of LSCs that are truncated in the right-truncation operation. The truncation parameter may be determined in many different ways and is defined at design time. The CCT follows from the truncation parameter if it has to be chosen to fully compensate for the largest possible truncation error, e.g. in examples where faithful rounding is desired, because as t increases (i.e. more LSC are removed in the right-truncation operation), the larger the correction that is required and hence the larger the CCT. The value of the CCT is always less than t/2 but more generally is closer to around t/4 (or less in some cases). In an example where faithful rounding is desired, the value of t may be determined at design time in a potentially iterative process. Given a known position of the ULP, this defines an upper bound for the value of t, tₘₐₓ, i.e. right-truncation of all LSC after the position of the ULP. However, as there must be at least one constant correction bit (since if there is any truncation, the CCT is greater than zero), the truncation parameter is always less than this upper bound (t<tₘₐₓ). By selecting an initial value of t (e.g. t=tₘₐₓ−2), the number of constant correction bits that are required can be determined by calculating the CCT for the selected value of t (e.g. if CCT=5 units, then 3 bits are required, if CCT=8 units, then 4 bits are required, etc.). The sum of t and the number of constant correction bits cannot exceed tₘₐₓ and based on evaluation of this sum, the current value of t may be used or a further iteration may be performed with a different value of t (e.g. by decreasing t if the sum exceeds tₘₐₓ or increasing t if the sum is less than tₘₐₓ) until an optimum value of t is identified (e.g. as defined such that t is as close to tₘₐₓ as possible whilst ensuring that the sum does not exceed tₘₐₓ).

Whilst the examples of the right-truncation below refer to right-truncation of an addition array generated using the method of FIG. 1 with a signed input number that comprises an even number of bits, the truncation may also be applied to a signed or unsigned addition array from an even or odd number of input bits using the method of FIG. 4 and to an unsigned addition array from an even number of bits using the method of FIG. 5.

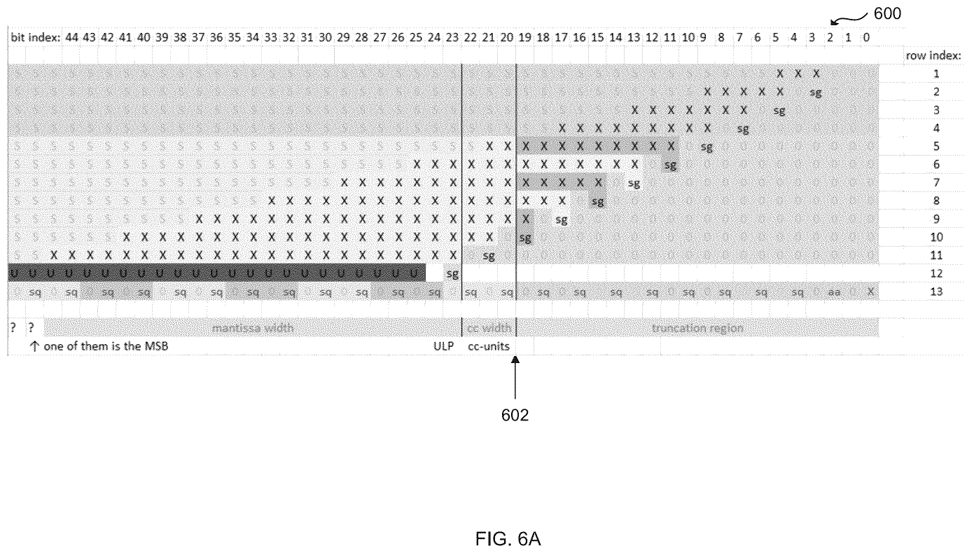

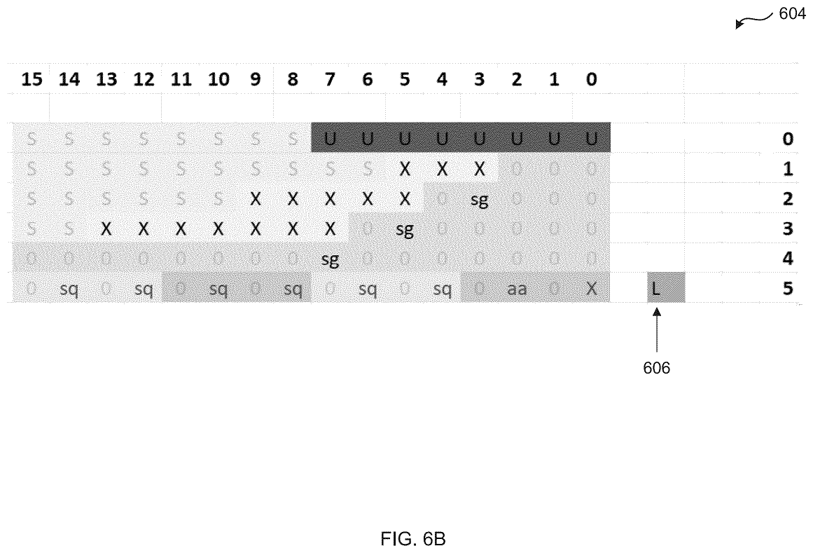

FIG. 6A shows the addition array 600 for m=24 and an unsigned input number generated using the method of FIG. 5. Rows 1-11 are the bit strings generated for values of i from i=1 to i=11 and row 12 is the extra string generated in block 515 along with a sign bit generated by the row above (row 11). Row 13 shows the square bits (sq). The sign bits (sg) are shown aligned with and below the rows that generate them (i.e. they are in the subsequent row to the rows that generated them) although, as described above, they may be combined into a single string with the square bits in row 13 (in block 114) before being included in the addition array. For clarity, positions in the array 600 that definitely contain zeros (e.g. the trailing zeros and values of bits that are definitely zero) are shown as zeros. Sign extension bits are marked with an S. Those positions which comprise bits from the original input number are marked with an X or a U (in the case of row 12) and the bit in row 13, bit index 2, marked aa, is the bit that is set based on the values of the two LSBs of the input number and is determined to be a₁ AND NOT a₀ (as shown in FIG. 3 and described above).

For the purposes of this example, it is assumed that the output comprises, for integers, the 24 MSBs, or for floating point numbers, a mantissa comprising 23 bits. For floating point (FP) numbers, the mantissa is preceded by a leading one, so in both the FP and integer case, it is necessary to determine the position of the leading one and the values of the next 23 consecutive bits (in order of reducing significance). As indicated in FIG. 6 by the question marks in bit positions 46 and 47, the position of the leading one is known to within one bit position (i.e. the leading one lies in bit position 46 or 47). This is implicit in this example because for floating point numbers with 23 mantissa bits, the square of the integer significand input must lie between 2⁴⁶ and 2⁴⁷.

As shown in FIG. 6A, in this example the ULP corresponds to a bit in bit position 23, i.e. the bit position of the least significant bit that could form part of the output (i.e. if the leading one is in the right-most bit position of the pair of possible bit positions shown with question marks). For the purposes of this example, the maximum error is required to be less than 1 ULP to guarantee faithful rounding. Then the truncation line 602 is calculated based on the maximum possible value of the truncated bits (i.e. assuming all Xs are ones). In this example, if the truncation line is positioned as shown, the bits in the truncated region in rows 1-4, 13 and 14 along with the sign bit shown in brackets in bit position 9 and row 5 represents an S10 squarer. The maximum value of this truncated region is given by (−2⁹)²=2¹⁸ and this represents 0.25 constant correction units. As all non-zero and non-sign bits in rows 1-4 have been truncated, the entire rows can be truncated. There are 5 possible carry chains up to the constant correction units (bits 20-22), triggered by the sign bits in bit positions 11, 13, 15, 17 and 19, so at most 5 constant correction units are required to cover them. This is a conservative estimate as they cannot all carry, as full carry chains in rows 1 and 2 would result in some zero Booth encodings in block 102, causing some of the next sign bits to be low. These 5 constant correction units can fit within the three constant correction units (columns 20-22) and correspond to ⅝ ULP and so truncating 20 LSCs (a right-truncation operation with t=20) meets the error requirements.

FIG. 6B shows the addition array 604 for p=9 and a signed input number generated using method B of FIG. 4. Rows 1-3 are the bit strings generated for values of i from i=1 to i=3 and row 0 is the extra string generated in block 410. Row 5 includes the LSB 606. This is shown in FIG. 4 as being appended (in block 414) after addition of the array (in block 120); however in this example it is appended to one of the strings the array before the addition (in block 120). Row 5 shows the square bits (sq) and the sign bits (sg) are shown aligned with and below the rows that generate them although, as described above, they may be combined into a single string (in block 114) before being included in the addition array. In the same manner as FIG. 6A, in FIG. 6B, positions in the array 604 that definitely contain zeros are shown as zeros. Sign extension bits are marked with an S. Those positions which comprise bits from the original input number are marked with an X, U (in the case of row 0) or L (in the case of row 5) and the bit in row 5, bit index 2, marked aa, is the bit that is set based on the values of the two LSBs of the input number and is determined to be a₁ AND NOT a₀ (as shown in FIG. 3 and described above).

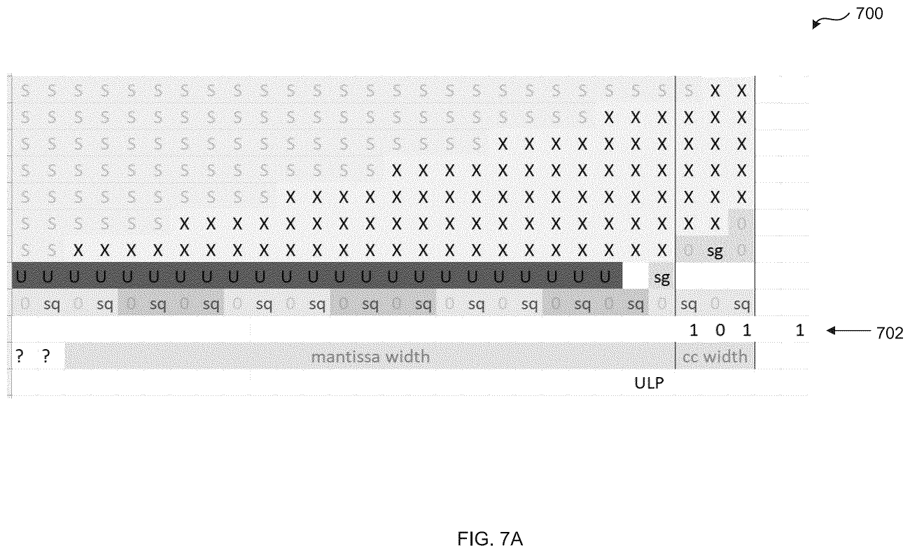

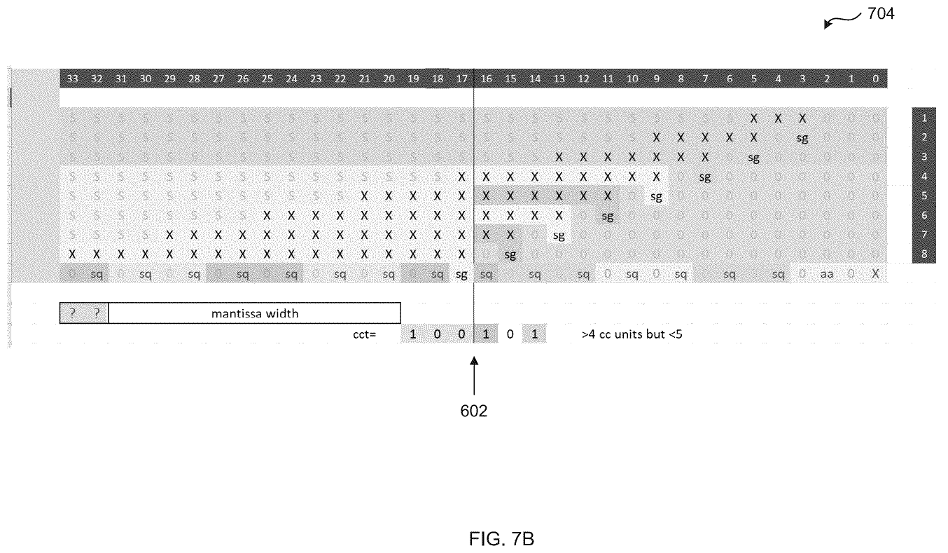

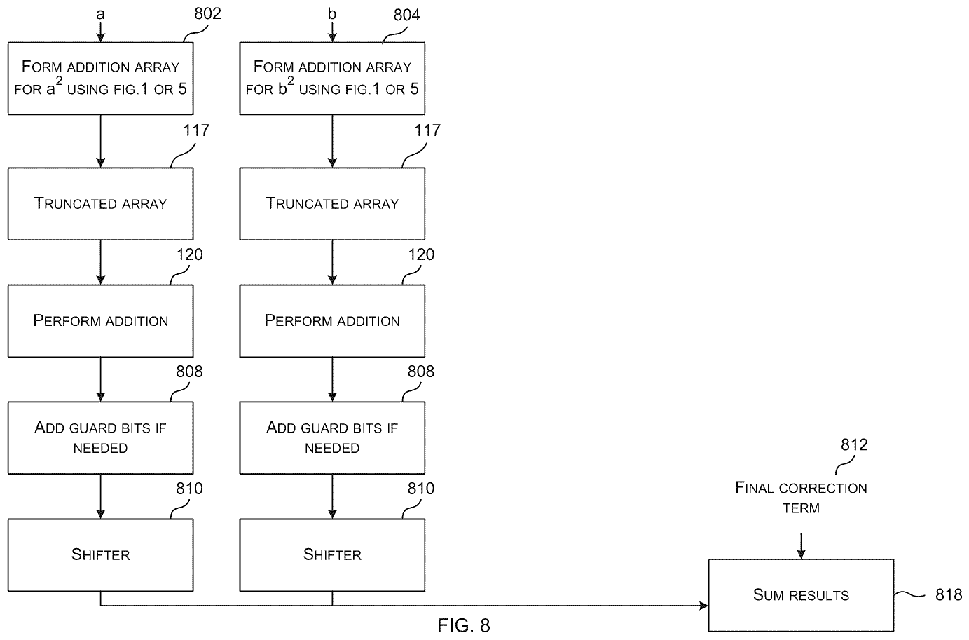

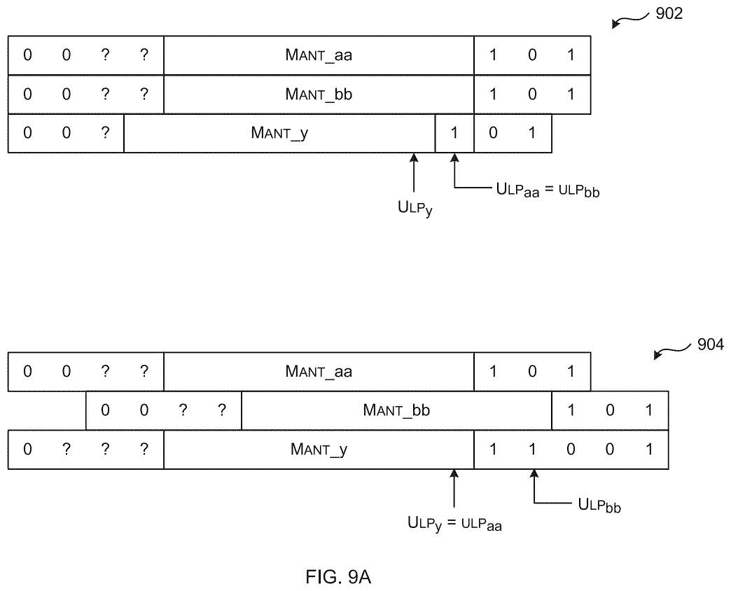

FIG. 7A shows the truncated array 700 that corresponds to the addition array 600 shown in FIG. 6A. The maximum truncation error bound 702, which has a value of 5.25 (as determined above) has been added into the array. It can be compensated by a correction by 5 correction units because the truncated bits in the original array captured by the fractional correction unit would never carry into the bit range of the correction range. Generally, maximum error bounds can be safely rounded down to whole correction units where a single squarer result is required to a given precision. See below for examples of a sum of squares required to a given precision where maximum error bounds must be rounded up to whole cc units, as errors beyond the truncation line of several squarers may carry into the correction range.

As the amount of truncation that can be performed without reaching the maximum error (e.g. 1 ULP) is dependent upon the format of the output result and the value of m and not upon the actual bit values in m, the position of the truncation line can be determined at design time. As extra bits have been truncated, this reduces the size of the hardware that is required to perform the addition of the bits in the addition array (in block 120), i.e. the hardware only requires adders configured to add the remaining columns of bits (e.g. columns 20-47 in the example shown). In addition, where the truncation removes entire rows, e.g. rows for values of i=1-4 in the example shown in FIG. 6A, the encodings for those fully truncated rows need not be performed and the resultant hardware can be omitted (e.g. in the methods of FIGS. 1, 4 and 5, the minimum value of i may be given by iₘᵢₙ, where iₘᵢₙ is the value of i corresponding to the first row that is not fully truncated, instead of i=1. In the example from FIG. 6A, iₘᵢₙ=5.

The truncation described above may be used to provide a faithfully rounded result for floating point numbers (e.g. when calculating the mantissa), or for results with bounded absolute errors on integers (e.g. when squaring neural network weights) or fixed point numbers.

In various examples, the methods described above may also be applied when calculating the sum of two or more squares which is a very common calculation. In various examples, a sum of squares may be used when calculating the length of a 2D vector (a,b) which is given by a²+b² or the length of a 3D vector (a, b, c) which is given by a²+b²+c² and this may, for example, be used when performing ray tracing in a GPU. If each of the squares are calculated separately, with the result being truncated before being output (e.g. because the numbers may be floating point numbers), then any errors caused by truncation are compounded by the final addition operation (i.e. when adding the squares together). However, if the truncation operation was moved later, such that the result of the squaring operations were not truncated but instead the output from the final addition was truncated, the hardware required to both perform the squaring and the hardware to perform the addition of the squares would be much larger, as there would be significantly more bits to add. The following examples perform separate squares and demonstrate how to control the compound error to remain under 1 ULP of the final output precision even if two or three individual truncated squarers with more than a 0.5 ULP error each at their respective truncation line are used. The examples of sums of 2 or 3 squares consist of individual squarers with input mantissa width 16 and a constraint that the sum of squares be faithfully rounded (i.e. with less than 1 ULP error) to a mantissa width of 12. It can be determined that such an individual square can be truncated by 17 bits before array summation (with the addition array 704 shown graphically in FIG. 7B), resulting in a maximum error of less than 5 units at the truncation line, corresponding to less than ⅝ULPs with respect to the final output precision. Due to potential carries from several individual squarer bits that are to be truncated in the sum of squares, the error is now rounded up to 5 correction units to ensure each squarer enters the final summation logic with a positive error.

FIG. 8 is a flow diagram of an example method of calculating a sum of squares to provide a faithfully rounded result which can be implemented efficiently in hardware and in particular which requires a reduced area of hardware compared to known methods. FIG. 8 shows receiving two input values a and b, and hence the method is used to sum two squares, a² and b²; however, in other examples the method may be used to sum three squares (generated from three input values) or more than three squares (generated from the corresponding number of input values).

As shown in FIG. 8, the method comprises forming the addition array for each of the squares individually (blocks 802, 804) using one of the methods described above (e.g. as shown in FIG. 1 or FIG. 5 up to block 116 or FIG. 4 up to block 412). In various examples, these addition arrays may be generated substantially in parallel.

As described above, the addition arrays (as generated in blocks 802, 804) may be truncated (in blocks 117) before summing the bits in the array (in blocks 120), although in other examples, no truncation may be performed (blocks 117 may be omitted). As described above, the truncation (in blocks 117) may remove columns of bits from the addition array and, in various examples, may also remove all the bits that are not known to be zero in a row and hence remove the entire row from the truncation array (and hence increase the value of iₘᵢₙ).

In various examples, the maximum possible amount of truncation is defined by the maximum acceptable error and as described above this may be expressed as a fraction of an ULP for the particular squarer output. It will be appreciated that an ULP may be different for the two squarer outputs (e.g. for a² and b² in the example of FIG. 8) and may be different from the ULP of the final result of summing the squares. When performing a sum of squares, the truncation (and hence the CCTs) are determined such that the overall ULP error in the output result meets the maximum acceptable error requirements (e.g. less than 1 ULP in the final output).

Having formed the arrays and performed any truncation, the addition of the arrays is performed (blocks 120). Before the results of the two squares are combined and summed (in block 818 along with a final correction term 812 where required), guard bits are added if needed (blocks 808) and one of the results may be shifted right by an even number of bits relative to the other result (blocks 810). Shifting is applied where the exponents of the two input numbers differ, in order to align the mantissas appropriately. As the relative alignment of squares is input dependent, a shifter (blocks 810) is shown in FIG. 8 in each squarer's path to align them quickly in parallel. If a sorter is inserted across both paths, e.g. between blocks 120 and blocks 808, one of the shifters 810 can be removed as the square with the largest exponent, if known and multiplexed onto a fixed path, need not be aligned. This adds delay but may reduce area in scenarios with large available slack (i.e. where delay is not critical). In any case, where shifting is performed, this may add additional error for the shifted squarer (i.e. one of the squares in a sum of two squares, or two of the sum of three squares) and this may result in a non-zero final correction term, as shown in some of the examples below.

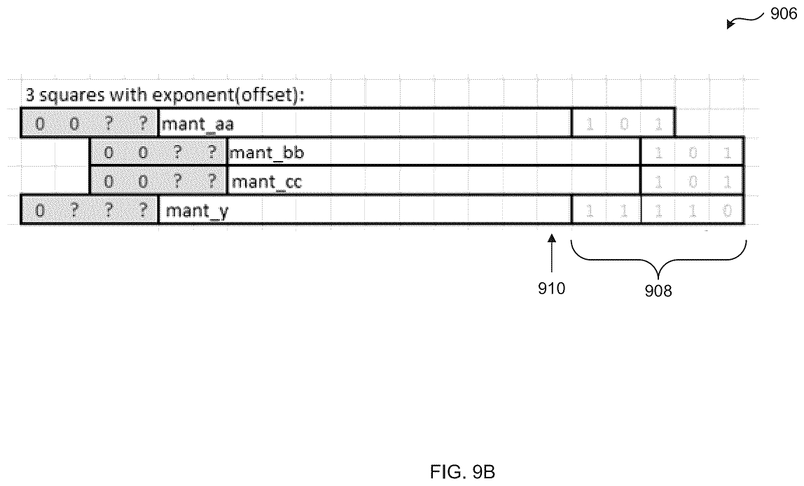

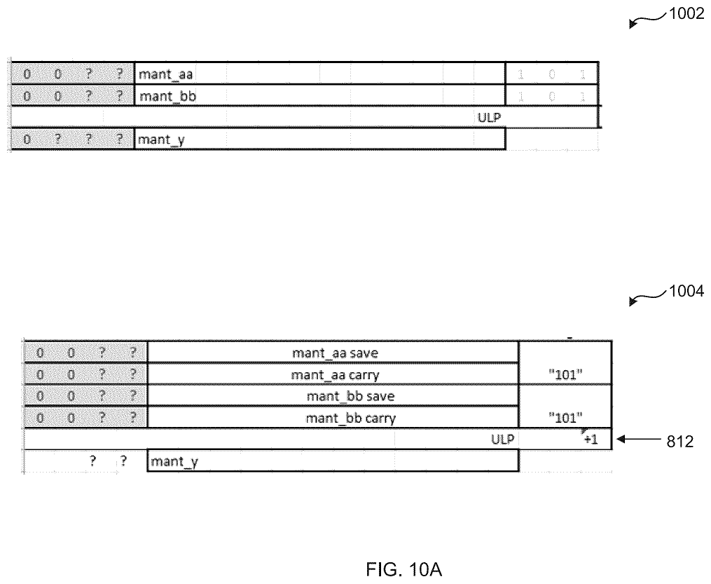

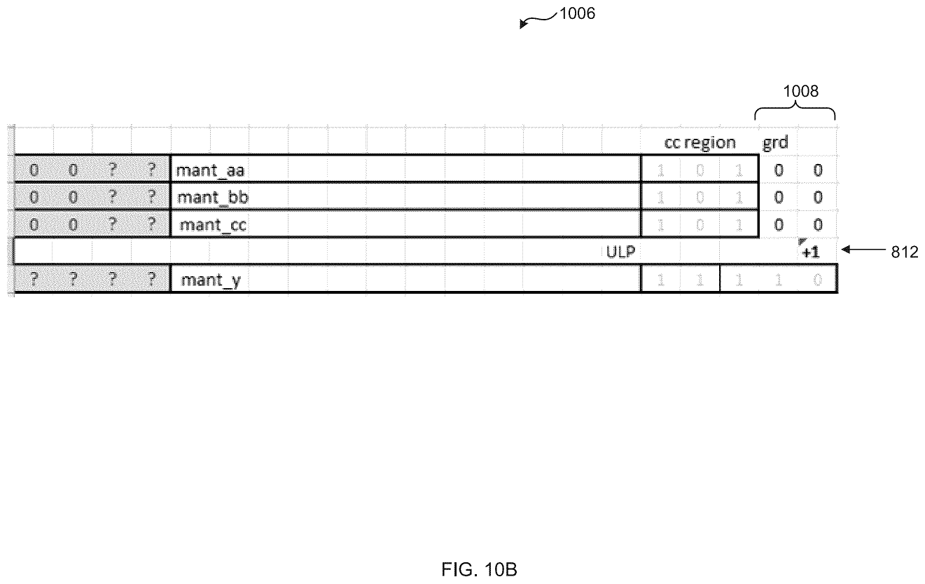

FIG. 9A shows graphical representations of two example sums of squares 902, 904. These examples show the sum of two squares, y=a²+b² where a and b are floating point numbers. In the first example 902, the two exponents (i.e. the exponent of a and the exponent of b) are the same and so no shifting is required. Furthermore, both the squares have the same size ULP (ULPₐₐ=ULP_{bb}), whereas the output result has a larger ULP (ULP_{y}) because the leading one is guaranteed to shift by at least one bit as a consequence of the sum of the squares. In this example, the maximum error in the sum of squares is ⅝ ULP with respect to the output precision.

In the second example 904, the exponent of input a is 1 larger than the exponent of input b and there is an offset of two bit positions (because squaring doubles the exponents) that is implemented in the shifters 810. In this case the position of the leading one is not guaranteed to shift (as indicated by the positions of the question marks in the third row). In this example, the maximum error in the sum of squares is 25/32 ULP and hence is still less than one ULP with respect to the output precision.

FIG. 9B shows a graphical representation of an example sum of squares 906 which shows the sum of three squares, y=a²+b²+c², where a, b and c are floating point numbers. In this example there is an offset in the exponents such that one square, a², is not shifted but the other two are shifted. The constant correction bits (or region) 908 is shown and this demonstrates that the maximum error is 15/16 of the output ULP 910 and hence is still less than one ULP.

Guard bits may be added in cases where the maximum error of final addition 818 with correction term 812 compensating for truncation errors from shifters 810 would be larger than the maximum acceptable error, in particular in some examples where shifting occurs or where the addition result from each squarer is kept in carry-save format and the final CPA is omitted from the addition (as discussed below), and the use of guard bits is shown in some of the examples below. By adding guard bits, the truncation error due to shifting is reduced (i.e. because the truncation error is pushed out by one bit position to the right for each guard bit that is added, and final correction term 812 can be reduced accordingly).

The addition that is performed on each of the separate squarer arrays (in blocks 120) may be the full addition, including the carry-propagate add operation that reduces the number of rows from two rows to a single row, as is required in the methods of FIGS. 1, 4 and 5 to obtain the final result. Alternatively, however, the addition (in blocks 120) may terminate prior to the CPA operation, resulting in two rows being output for each square from blocks 120 instead of one row per square. In the event that the addition terminates early, almost two units of error can be added at the truncation line of the shifted squarer and therefore a constant correction term 812 of +1 is added (in block 818) to compensate and guard bits are not required (i.e. none are added in block 808). This is sufficient as the actual maximum error can once again be rounded down to whole correction units, being the final error incurred before output to the required precision. As the precision-critical positive error in block 902 from two squares with respective correction terms +5 amounts to 25/32 ULPs and the final correction term 812 amounts to ⅛ ULP, the total of critically aligned constant corrections in this example is 29/32 ULPs, thus less than 1 ULP and acceptable for the maximum error requirement. Had the total correction with the final correction term 812 exceeded 1 ULP, one or several guard bits would have been needed (in block 808) before the shifters (block 810).

FIG. 10A shows graphical representations of two further example sums of squares 1002, 1004. These examples show the sum of two squares, y=a²+b² where a and b are floating point numbers. In the second of these examples, the final correction term 812 is non-zero.

In the first example 1002 shown in FIG. 10A, no final correction term is added in the final summation (in block 818) as the truncation error due to shifting is less than one constant correction unit, no final correction term is required. In this case the positive worst case total error is given by ( 25/32) ULP which is still less than 1 ULP.

In the second example 1004 shown in FIG. 10A, the final CPA operation of the addition (in block 120) has been omitted so the final summation involves two rows per input value (the save row and the carry row). With two rows of a possibly less significant square being shifted by shifter 810, the truncation error (without guard bits) is less than two constant correction units. A final correction term 812 which corresponds to ⅛ ULP is added in the final summation (in block 818) since the truncation error due to shifting could be more than one constant correction unit but is less than two constant correction units and hence one constant correction unit (=⅛ ULP) is sufficient to compensate. In this example the positive worst case total error is given by ( 25/32+⅛) ULP= 29/32 ULP which is still less than 1 ULP.

FIG. 10B shows a graphical representation of another example sums of squares 1006. This example shows the sum of two squares, y=a²+b²+c², where a, b and c are floating point numbers. In this example, the final correction term 812 is non-zero and because two squares have been shifted, the truncation error is now less than two constant correction units and hence one constant correction unit (=⅛ ULP) is sufficient. However adding ⅛ ULP or 1/16 ULP would result in a positive worst case total error of 1 ULP or more and so guard bits 1008 are required. In this example two guard bits are added in order to quarter the truncation error (to 1/32 ULP) and this has the effect that the positive worst case total error is less than 1 ULP, as required for faithful rounding.

The method of FIG. 8 and the examples described above in FIGS. 9A, 9B, 10A and 10B relate to input numbers that are floating point numbers. A similar method may be used for input numbers that are integers. Where the input numbers are integers they are automatically aligned and no shifting is required to align them (shifters 810 are omitted). As no shifting is required, the optionally truncated arrays for each of the squares may be added in a single addition operation (i.e. blocks 120 may be combined into block 818).

Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), physics processing units (PPUs), radio processing units (RPUs), digital signal processors (DSPs), general purpose processors (e.g. a general purpose GPU), microprocessors, any processing unit which is designed to accelerate tasks outside of a CPU, etc. A computer or computer system may comprise one or more processors. Those skilled in the art will realize that such processing capabilities are incorporated into many different devices and therefore the term ‘computer’ includes set top boxes, media players, digital radios, PCs, servers, mobile telephones, personal digital assistants and many other devices.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processor, or other hardware logic element, configured to perform any of the methods described herein, or to manufacture a processor comprising any apparatus described herein. An integrated circuit definition dataset may be, for example, an integrated circuit description.

Therefore, there may be provided a method of manufacturing, at an integrated circuit manufacturing system, a processor, squarer or other hardware logic configured to perform a method as described herein. Furthermore, there may be provided an integrated circuit definition dataset that, when processed in an integrated circuit manufacturing system, causes the method of manufacturing a processor, squarer or other hardware logic configured to perform a method as described herein to be performed.

An integrated circuit definition dataset may be in the form of computer code, for example as a netlist, code for configuring a programmable chip, as a hardware description language defining an integrated circuit at any level, including as register transfer level (RTL) code, as high-level circuit representations such as Verilog or VHDL, and as low-level circuit representations such as OASIS® and GDSII. Higher level representations which logically define an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

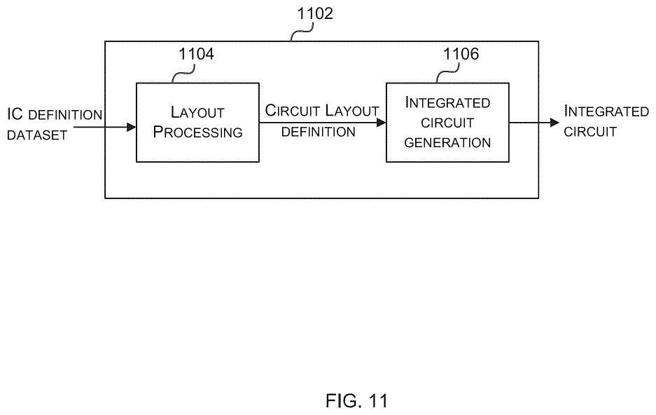

An example of processing an integrated circuit definition dataset at an integrated circuit manufacturing system so as to configure the system to manufacture a processor, squarer or other hardware logic configured to perform a method as described herein will now be described with respect to FIG. 11.

FIG. 11 shows an example of an integrated circuit (IC) manufacturing system 1102 which is configured to manufacture a processor, squarer or other hardware logic configured to perform a method as described herein. In particular, the IC manufacturing system 1102 comprises a layout processing system 1104 and an integrated circuit generation system 1106. The IC manufacturing system 1102 is configured to receive an IC definition dataset (e.g. defining a processor, squarer or other hardware logic configured to perform a method as described herein), process the IC definition dataset, and generate an IC according to the IC definition dataset (e.g. which embodies a processor, squarer or other hardware logic configured to perform a method as described herein). The processing of the IC definition dataset configures the IC manufacturing system 1102 to manufacture an integrated circuit embodying a processor, squarer or other hardware logic configured to perform a method as described herein.

The layout processing system 1104 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1104 has determined the circuit layout it may output a circuit layout definition to the IC generation system 1106. A circuit layout definition may be, for example, a circuit layout description.

The IC generation system 1106 generates an IC according to the circuit layout definition, as is known in the art. For example, the IC generation system 1106 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1106 may be in the form of computer-readable code which the IC generation system 1106 can use to form a suitable mask for use in generating an IC.

The different processes performed by the IC manufacturing system 1102 may be implemented all in one location, e.g. by one party. Alternatively, the IC manufacturing system 1102 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processor, squarer or other hardware logic configured to perform a method as described herein without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 11 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 11, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A method of calculating a square of an input number in hardware logic, comprising:
receiving an m-bit number, where m is an even integer;
performing Booth encoding on a plurality of different groups of three consecutive bits selected from the m-bit number to generate an encoded value for each of the groups of bits;
for each group of three consecutive bits:
forming a truncated string from the input number;
generating an updated version of the truncated number using the most significant bit of the group of three consecutive bits; and
selecting a bit string based on the encoded value, the selected bit string comprising zeros or a left-shifted version of the updated version of the truncated number sign extended to a bit-width of 2m bits;
combining the selected bit strings for each of the groups and square and sign bits for each group into an addition array, the square bits for a group comprise two bits set based on the encoded value for the group and the sign bit for a group comprises a bit set based on the three consecutive bits in the group; and
summing the bits in the addition array.

2. The method according to claim 1, further comprising creating a further string by interleaving square and sign bits for each group and wherein combining the selected bit strings for each of the groups and square and sign bits for each group into the addition array comprises:
combining the selected bit strings for each of the groups and the further string into an addition array.

3. The method according to claim 2, wherein creating a further string by interleaving the square and sign bits comprises:
setting a least significant bit in the further string equal to a least significant bit in the m-bit number;
setting a bit in bit position one in the further string to zero;
setting a bit in bit position two in the further string to a bit value determined by inverting the least significant bit in the m-bit number and combining the inverted bit with a next least significant bit in the m-bit number in an AND logic element;
setting remaining bits in the further string by interleaving sign and square bits in order of increasing value of i used to generate the encoded value.

4. The method according to claim 1, wherein the input number is the m-bit number and wherein the input number is a signed number.

5. The method according to claim 1, wherein the input number is an m−1 bit number and wherein the input number is unsigned and wherein the method further comprises:
generating the m-bit number by prepending a leading zero to the input number.

6. The method according to claim 1, wherein the input number is an m+1 bit number and wherein the input number is signed and wherein the method further comprises:
generating the m-bit number by removing a least significant bit from the input number;
prior to summing the bits in the addition array, generating an extra string by performing a bitwise AND of the input number without the least significant bit with the replicated removed least significant bit and sign extending to a width of the additional array and adding the extra string to addition array;
and subsequent to summing the bits in the addition array, appending a training zero followed by the removed significant bit.

7. The method according to claim 1, wherein the input number is the m-bit number and wherein the input number is unsigned and wherein the method further comprises, prior to summing the bits in the addition array, generating an additional string by removing a most significant bit from the input number and appending m+1 trailing zeros and adding the extra string to addition array.

8. The method according to claim 1, further comprising:
deforming the addition array prior to summing the bits.

9. The method according to claim 8, wherein deforming the addition array comprises:
inverting a sign bit in each of the left shifted and sign extended truncated strings;
replacing the three least significant sign extended bits with ones; and
replacing any more significant sign extended bits with zeros.

10. The method according to claim 1, wherein performing Booth encoding on a plurality of different groups of three consecutive bits selected from the m-bit number to generate an encoded value for each of the groups of bits comprises:
for each integer value of i from i=iₘᵢₙ to i=(m/2)−1:
selecting a group of three bits in positions 2i+1, 2i and 2i−1 in the m-bit number, wherein a bit in position 0 is a least significant bit and a bit in position m−1 is a most significant bit;
generating an encoded value by Booth encoding the selected group of bits.

11. The method according to claim 10, wherein forming a truncated string from the input number comprises:
based on the value of i used to generate the encoded value, left-truncating the input number to form a truncated string comprising bits in positions 2i−1 to zero.

12. The method according to claim 10, wherein generating an updated version of the truncated number using the most significant bit of the group of three consecutive bits comprises:
performing a bitwise XOR of the truncated number with a replicated version of the most significant bit of the group of three consecutive bits.

13. The method according to claim 10, wherein selecting a bit string based on the encoded value comprises:
if the encoded value is ±2, selecting a bit string comprising the truncated string with the most significant bit of the group appended followed by 2i+1 trailing zeros and sign extended to a bit-width of 2m bits;
if the encoded value is ±1, selecting a bit string comprising the truncated string with 2i+1 trailing zeros appended and sign extended to a bit-width of 2m bits; and
otherwise selecting a bit string comprising all zeros.

14. The method according to claim 10, wherein iₘᵢₙ=1 or iₘᵢₙ>1.

15. The method according to claim 1, further comprising:
right-truncating the addition array prior to summing the bits.

16. The method according to claim 15, wherein right-truncating the addition array comprises:
truncating all bits to the right of a truncation line; and
adding a constant correction term, wherein the constant correction term has a value that is greater than a maximum possible value of the truncated bits.

17. A method of calculating a sum of squares in hardware logic, the method comprising:
receiving two or more input floating point numbers, each number comprising an exponent and a mantissa;
for each input floating point number, calculating a square of the mantissa of each input number according to the method as set forth in claim 1; and
summing the calculated squares.

18. The method according to claim 17, further comprising, prior to summing the calculated squares:
aligning the calculated squares based on the exponents of each of the input floating point numbers; and
adding a final correction term, wherein the final correction term is dependent upon the aligning.

19. The method according to claim 17, wherein each calculated square comprises a pair of bit strings, the pair of bit strings comprising a string of carry bits for the calculated square and a string of save bits for the calculated square.

20. Hardware logic configured to perform the method as set forth in claim 1.
